(19) United States
(12) Patent Application Publication
(10) Pub. No.: US 2003/0087008 A1
(43) Pub. Date: May 8, 2003

(54) Molded animal chew toys with realistic appearance

(75) Inventor: Glen S. Axelrod, Colts Neck, NJ (US)

Correspondence Address: Steven J. Grossman, Hayes, Soloway, Hennessey, Grossman & Hage, P.C., 175 Canal Street, Manchester, NH, 03101, US

(73) Assignee: THF Publications, Inc.

(21) Appl. No.: 10/039,549

(22) Filed: Nov. 7, 2001

(51) Int. Cl. A23G 1/00

(52) U.S. Cl. 426/104

(57) ABSTRACT

An improved animal chew toy and process for forming such chew toy including the molding of the chew toy in the form of an identifiable food product with a realistic appearance that is suggested by an olfactory attractant, a flavorant, or a major ingredient included in the chew toy. The chew toy is preferably made from ingredients that can be ingested by the animal.

### FIELD OF THE INVENTION

The present invention relates to an improved animal chew toy and process for forming such chew toy comprising the molding of the chew toy in a form with a realistic appearance, in the sense that the chew toy appears, e.g. as an identifiable food product corresponding to the flavor, scent or a major ingredient of the chew.

### BACKGROUND OF THE INVENTION

It has long been recognized that most dogs derive amusement and various health benefits from chewing. Typical dog chews have been formed from materials such as cow bones, wood, nylon, polyurethane or rubber. However, many of these materials are indigestible by dogs, and once swallowed, these objects or fragments can have an adverse effect on the dog's digestion and can become impacted in the dog's intestinal tract with life-threatening consequences. By way of example, dog chews have been marketed which utilize an ethylene copolymer which can be fractured by the chewing action of a dog, and when ingested can block the dog's stomach passages.

Applicant's assignee, T. F. H. Publications Inc., has previously developed a variety of edible dog chews that are wholly digestible and nutritious. Such dog chews utilize a mixtures containing primarily casein, rawhide products or potato starch. In order to entice the dog to engage in chewing, and to increase the dog's enjoyment, the chews often include attractants and/or flavorings. Exemplary attractants have included chicken powder, liver powder, ham, turkey, beef and or fish. Natural vegetable additives such as spinach or carrots also may be added. The resultant mixture is molded under heat and pressure into a desired form, such as a dog bone.

In Applicant's U.S. patent application Ser. No. 09/138,804, which is a continuation-in-part of U.S. Pat. No. 5,827,565, there is disclosed a dog chew having natural fruit flavor to increase the dog's appetite for such chew. Such fruit flavored dog chew may also include natural food coloring to enhance the attractiveness of the chew to the dog owner. The food coloring may also correspond to the fruit flavor, and the dog chew disclosed therein may also embody a breath sweetener for a dog such as mint, spearmint, peppermint or wintergreen and may also include parsley. The preferred form of such edible chew maintained the basic ingredient of a heat-expandable starch, such as potato starch. Fruit flavoring may be added to the granules of a mixture of potato starch, water and calcium carbonate along with natural fruit flavorings.

Attention is also directed to the following U.S. patents and copending applications, commonly owned by the assignee herein: U.S. Pat. No. 5,476,069; U.S. patent application Ser. No. 08/923,070 filed Sep. 3, 1997 entitled “Vegetable Based Dog Chew”; now U.S. Pat. No. 6,093,427 Ser. No. 08/738,423 filed Oct. 25, 1997 entitled “Edible Dog Chew” now U.S. Pat. No. 5,827,565; Ser. No. 08/784,834 filed Jan. 17, 1997 entitled “Carrot-Based Dog Chew” now U.S. Pat. No. 5,941,197; Ser. No. 08/888,611 filed Jul. 7, 1997 entitled “Vegetable Dog Chew” abandoned; Ser. No. 09/114,872 filed Jul. 14, 1998 entitled “Heat Modifiable Edible Dog Chew”; Ser. No. 09/138,804 filed Aug. 21, 1998 entitled “Improved Edible Dog Chew” now U.S. Pat. No. 6,126,978; Ser. No. 09/116,070 filed Jul. 15, 1998 entitled “Wheat & Casein Dow Chew With Modifiable Texture” now U.S. Pat. No. 6,110,521; Ser. No. 09/116,555 filed Jul. 15, 1998 entitled “Heat Modifiable Peanut Dog Chew” now U.S. Pat. No. 6,093,441; Ser. No. 09/227,767 filed Jan. 8, 1999 entitled “Method of Molding Edible Starch.” In addition to such patents and applications, attention is also directed to the art cited in said patents and applications, as such art relates to the field of molded starch products.

As can therefore be seen upon review of the above, while a variety of patents have issued directed an animal chew products, there still exists, however, a need to develop a process to produce an animal chew toy with a realistic appearance, in the sense that the chew toy appears, e.g. as an identifiable food product, such as a bacon strip, a carrot, an egg, etc. There also exists a need to manufacture such an animal chew from ingredients that can be safely ingested by the animal, and which also may provide the animal with a separate source of nutrition.

Accordingly, it is an object of this invention to develop a process and formulation to prepare an animal chew toy with a realistic appearance, and which animal chew toy is made of natural ingredients that can be ingested by the animal.

### SUMMARY OF THE INVENTION

An animal chew toy comprising ingredients that can be ingested by the animal, which chew toy assumes the realistic shape of a selected food product, which shape corresponds to an ingredient, flavoring, and/or attractant included in the chew.

### BRIEF DESCRIPTION OF THE DRAWINGS

The invention will be better understood from a reading of the following detailed description taken in conjunction with the drawings in which like reference designators are used to designate like elements, and in which:

FIG. 1 is a perspective view of an animal chew in accordance with the present invention, in the shape of a carrot.

FIG. 2 is a perspective view of an animal chew in accordance with the present invention, in the shape of a beef bone.

FIG. 3 is a perspective view of an animal chew in accordance with the present invention, in the shape of bacon strip.

FIG. 4 is a perspective view of an animal chew in accordance with the present invention, in the shape of a lamb chop.

FIG. 5 is a perspective view of an animal chew in accordance with the present invention, in the shape of a slice of Swiss cheese.

FIG. 6 is a perspective view of an animal chew in accordance with the present invention, in the shape of a fried egg.

### DETAILED DESCRIPTION OF THE PREFERRED EMBODIMENTS

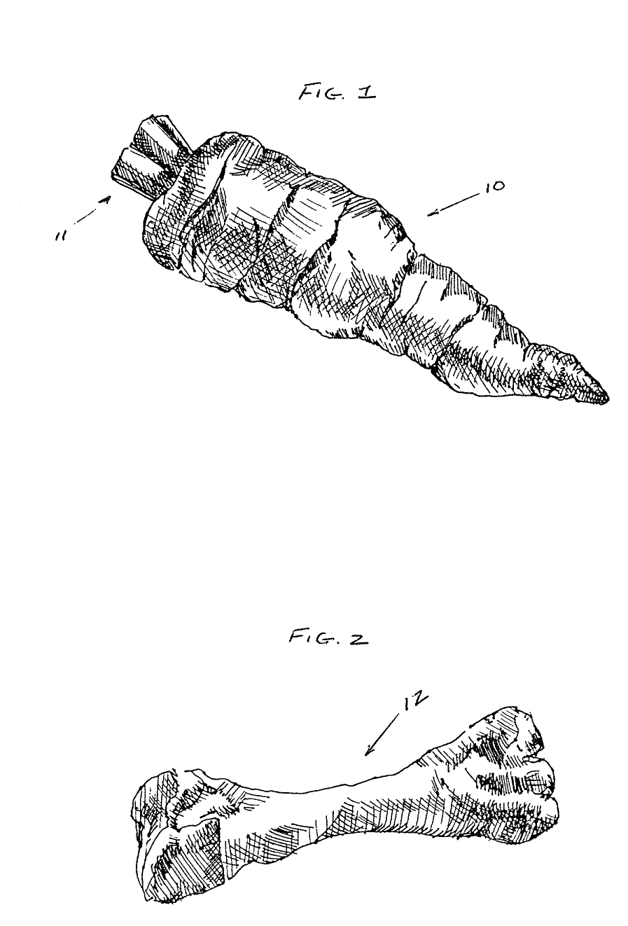

As illustrated in FIGS. 1 through 6, animal chews may be formed having a realistic shape corresponding to an ingredient, flavoring or attractant included in the chew. Preferably the animal chew comprises an edible base material, which may include casein, potato starch, and rawhide products. These base materials may be enhanced by being combined with vegetable and meat products as well as colorants, flavoring, and olfactory attractants. The enhanced material may then be formed into any desired shape by processes such as injection molding or compression molding.

As mentioned above, the animal chew toys consistent with the present invention are preferably molded, or otherwise formed, into shapes that are suggestive or reminiscent of known food products corresponding to an ingredient, flavoring or attractant included in the animal chew toy. Preferably, the animal chew toy is formed into shapes that realistically resemble a known food product corresponding to an ingredient, flavoring or attractant included in the chew toy. The principle of a corresponding shape is illustrated below with reference to several exemplary embodiments.

In a first embodiment of the present invention, the realistic shape of the animal chew is in the form of a carrot, illustrated as 10 in FIG. 1. As can be seen from this illustration, the chew toy according to FIG. 1 is of a tapered cylindrical shape, including a section 11 which simulates the carrot stem. The tapered cylindrical shape also contains score lines on the surface thereof, in a manner that is consistent with that of a real carrot. Preferably, such a carrot chew is injection molded, and prepared from a mixture comprising carrots, casein and an attractant. While not necessarily flavored as a carrot, the animal chew toy of this embodiment comprises a relatively high content of carrot products, and is accordingly shaped as a carrot.

In a second embodiment, the realistic shape of the animal chew toy is in the form of a beef bone, illustrated as 12 in FIG. 2. Preferably, such a beef bone chew is injection molded and is prepared from a mixture comprising beef by-products, casein and preferably beef flavor. Consistent with the present invention, this exemplary animal chew is shaped as a beef bone corresponding to the inclusion beef by-products and/or beef flavor.

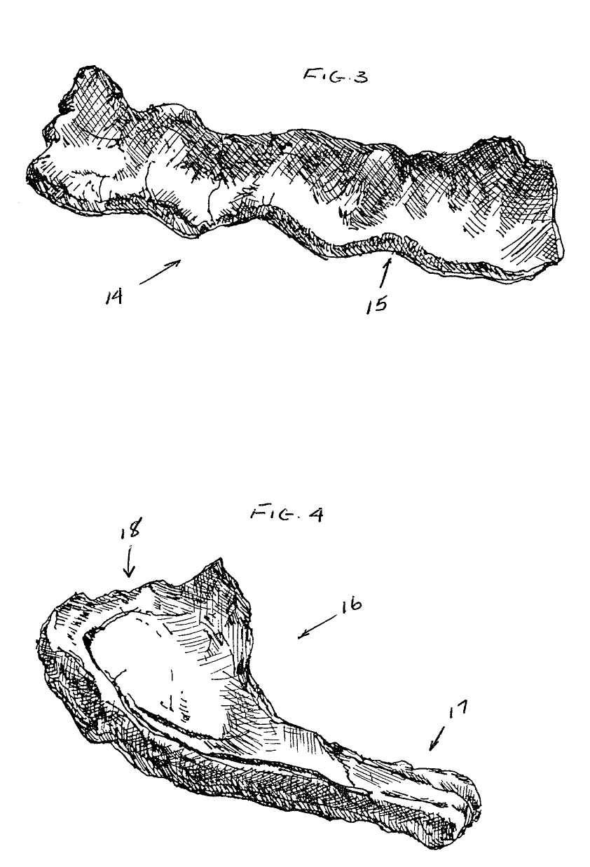

In a third embodiment, the realistic shape of the animal chew is in the form of a bacon strip, illustrated as 14 in FIG. 3. Such bacon strip 14 is of a generally rectangular shape and contains successive bends 15 typical of a real bacon strip. In addition, the strip may preferably contain light and dark colored sections, again, as found in a real bacon strip food product, and which light and dark colored regions preferably run lengthwise within said rectangular shape. Preferably, such a bacon strip is injection molded and is prepared from a mixture comprising beef by-products, casein, pork by-products, and/or bacon flavor and/or bacon scent. Corresponding to the bacon flavor and/or scent, the animal chew of this exemplary embodiment is formed to resemble a strip of bacon.

In a fourth embodiment, an animal chew having a content of lamb by-products, and desirably having a lamb flavor, is in the realistic shape of a lamb chop, illustrated as 16 in FIG. 4. Such lamb chop shape assumes a leg portion 17 which expands in to a wider cross-sectional profile 18. Preferably, such a lamb chop chew is injection molded and is prepared from a mixture comprising beef by-products, casein, and lamb meal.

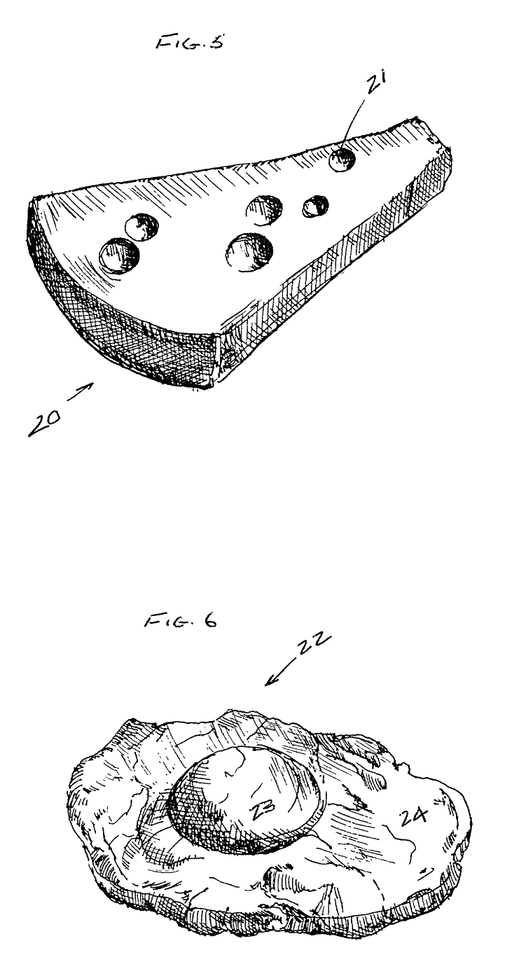

In a fifth embodiment, the realistic shape of the animal chew is in the form of a slice of Swiss cheese, illustrated as 20 in FIG. 5. Such Swiss cheese shape 20 appears in a classic pie shape oblong configuration including the realistic and random placement of craters 21. Preferably, such a Swiss cheese chew is prepared from an ingestible mixture comprising starch, casein, calcium carbonate and natural color to promote the appearance as a Swiss cheese food product. Furthermore, the animal chew of this embodiment additionally includes an olfactory attractant and/or a flavorant configured to respectively provide Swiss cheese scent and/or Swiss cheese flavor.

In a sixth embodiment, the realistic shape of the animal chew is in the form of a fried egg, illustrated as 22 in FIG. 6. Such fried egg shape 20 preferably contains a bulbous or domed yoke section 23 surrounded by a flatter simulated egg white section 24. Preferably such a fried egg chew is prepared from an ingestible mixture comprising potato starch, egg flavor, calcium carbonate and natural color to promote the appearance as a fried egg food product. Therefore, the fried egg shaped animal chew, while not actually containing any egg product, is flavored and shaped to resemble a fried egg.

As can be seen from the above, the present invention is directed at the preparation of an animal chew toy such that the chew toy assumes the realistic shape, color and appearance of a known food product corresponding to a flavor, scent or ingredient of the chew toy. Preferably, all such products are injection molded. In such fashion, the invention herein uniquely provides a complete family of animal chew toys which appears as a known food product to humans. In addition, the ingredients are all selected such that they can be ingested by the animal, and in such sense, are consistent with the visual image of a realistic food product noted herein.

What is claimed is:

1. An animal chew toy comprising ingredients that can be ingested by the animal, which chew toy assumes the shape of a carrot, and comprises a tapered cylindrical shape, including score lines on the surface thereof to simulate carrot texture.

2. An animal chew toy comprising ingredients that can be ingested by the animal, which chew toy assumes the shape of a bacon strip, and comprises a rectangular shape including successive bends in said rectangular shape.

3. The animal chew toy of claim 2 wherein said chew toy contains light and dark colored regions, said regions running lengthwise along said rectangular shape.

4. An animal chew toy comprising ingredients that can be ingested by the animal, which chew toy assumes the shape of a lamb chop and comprises a leg portion which expands into a wider cross-sectional profile.

5. An animal chew toy comprising ingredients that can be ingested by the animal, which chew toy assumes the shape of a slice of Swiss cheese and comprises a pie-shaped configuration, including surface craters.

6. An animal chew toy comprising ingredients that can be ingested by the animal, which chew assumes the shape of a fried egg and comprises a raised domed section that simulates the yoke section and a section connected to said yoke section that simulates the egg white section.

7. An animal chew toy comprising ingredients that can be ingested by the animal, wherein at least one of the ingredients is an olfactory attractant suggesting a food product and wherein the animal chew toy is shaped corresponding to the food product suggested by the attractant.

8. The animal chew toy according to claim 7 wherein the olfactory attractant provides bacon scent, and wherein the animal chew toy corresponds in shape to a strip of bacon.

9. The animal chew toy according to claim 7 wherein the olfactory attractant provides lamb scent, and wherein the animal chew toy corresponds in shape to a lamb chop.

10. The animal chew toy according to claim 7 wherein the olfactory attractant provides Swiss cheese scent, and wherein the animal chew toy corresponds in shape to a wedge of Swiss cheese.

11. The animal chew toy according to claim 7 wherein the olfactory attractant provides fried egg scent, and wherein the animal chew toy corresponds in shape to a fried egg.

12. The animal chew toy according to claim 7 wherein the olfactory attractant provides a beef scent, and wherein the animal chew toy corresponds in shape to a beef bone.

13. An animal chew toy comprising ingredients that can be ingested by the animal, wherein at least one of the ingredients is a flavorant suggesting a food product, and wherein the animal chew toy is shaped corresponding to the food product suggested by the flavorant.

14. The animal chew toy according to claim 13 wherein the flavorant provides bacon flavor, and wherein the animal chew toy corresponds in shape to a strip of bacon.

15. The animal chew toy according to claim 13 wherein the flavorant provides beef flavor, and wherein the animal chew toy corresponds in shape to a beef bone.

16. The animal chew toy according to claim 13 wherein the flavorant provides fried egg flavor, and wherein the animal chew toy corresponds in shape to a fried egg.

17. The animal chew toy according to claim 13 wherein the flavorant provides Swiss cheese flavor, and wherein the animal chew toy corresponds in shape to a wedge of Swiss cheese.

18. The animal chew toy according to claim 13 wherein the flavorant provides lamb flavor, and wherein the animal chew toy corresponds in shape to a lamb chop.

19. An animal chew toy comprising ingredients that can be ingested by the animal, wherein the animal chew toy is shaped corresponding to the food product suggested by at least one of the ingredients.

20. The animal chew toy according to claim 19 comprising beef products, wherein the animal chew toy corresponds in shape to a beef bone.

21. The animal chew toy according to claim 19 comprising pork products, wherein the animal chew toy corresponds in shape to a strip of bacon.

22. The animal chew toy according to claim 19 comprising lamb products, wherein the animal chew toy corresponds in shape to a lamb chop.

23. The animal chew toy according to claim 19 comprising carrot products, wherein the animal chew toy corresponds in shape to a carrot.

24. An animal chew toy comprising molded potato starch that can be ingested by the animal, wherein the animal chew toy is shaped to resemble a food product corresponding to at least one of an olfactory attractant, a flavorant, and an ingredient of the animal chew toy.

25. An animal chew toy comprising molded casein that can be ingested by the animal, wherein the animal chew toy is shaped to resemble a food product corresponding to at least one of an olfactory attractant, a flavorant, and an ingredient of the animal chew toy.

26. An animal chew toy comprising a molded raw hide product that can be ingested by the animal, wherein the animal chew toy is shaped to resemble a food product corresponding to at least one of an olfactory attractant, a flavorant, and an ingredient of the animal chew toy.
